(19) United States
(12) Patent Application Publication
(10) Pub. No.: US 2007/0081119 A1
(43) Pub. Date: Apr. 12, 2007

(54) Hide & see poker glasses

(76) Inventors: Zoltan Joseph Mayer, Royal Palm Beach, FL (US); Frank Joseph Rallo, Royal Palm Beach, FL (US)

Correspondence Address: Zoltan Joseph Mayer, 109 Brook Woode Ave, Royal Palm Beach, FL, 33411, US

(21) Appl. No.: 11/246,804

(22) Filed: Oct. 11, 2005

(51) Int. Cl. G02C 7/16

(52) U.S. Cl. 351/45

(57) ABSTRACT

Hide & See glasses were designed for playing poker, Some players are wearing sunglasses to hide their eyes from their opponents. While this is good as it hides your eyes it is difficult to see the cards clearly through dark sunglasses, especially in poor lighting conditions. Hide & See Through the design of the lens being dark smoke polarized and a clear lens inserted and positioned through the polarized lens at the lower part of the lens, hides your eyes from other players while giving you clear view of your cards.

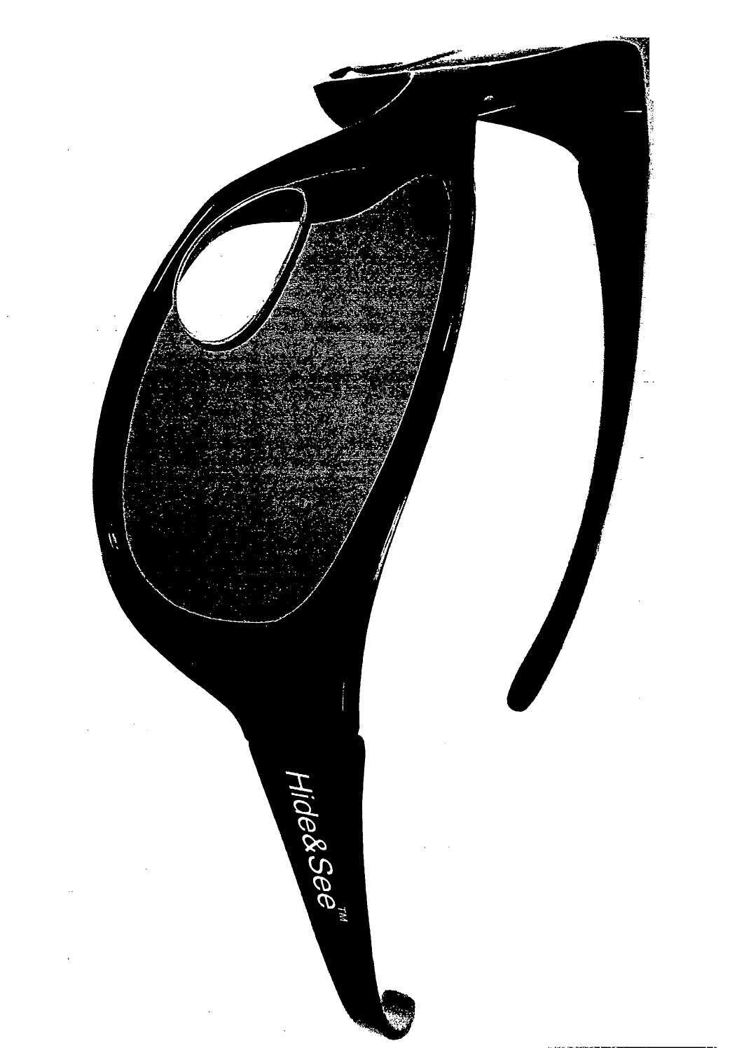

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Sunglasses are worn by some poker players, players do not want you to see their eyes or read them. Hide & See glasses hide your eyes from other players and through a clear area in lens you can see the playing cards clearly avoiding costly mistakes.

### BRIEF SUMMARY OF THE INVENTION

Poker players want to hide their eyes from other players so most wear sunglasses, With sunglasses you have difficulty in seeing your cards and players have misread their cards. Hide & See are sunglasses with a clear area in the bottom portion of the lens that lets you see your cards clearly.

### BRIEF DESCRIPTION OF THE SEVERAL VIEWS OF THE DRAWING

Not Applicable (see enclosed photo)

### DETAILED DESCRIPTION OF THE INVENTION

Hide & See poker glasses were designed so poker players would be able to hide their eyes while able to see their cards. Some poker players wear sunglasses as to hide their eyes, however it is difficult to see the cards with sunglasses. Companies are selling sunglasses and are calling them poker glasses. Other companies have a coating on a clear lens that help hide your eyes, however they have to be worn with a hat or the glare from the lights affect your vision. Some have a tilted lens that let you look down. Hide and See glasses were developed by trail and error testing different lens, the final design was a pair of safety glasses, sports style with a dark tint overlaid over the clear lens with an oval like cut out on the bottom of the lens to leave it clear. The clear area is positioned so when you look down at your cards you are seeing through the clear part of the lens while the smoke colored sunglass lens hides your eyes. While looking through clear part, you are looking through a clear oval like shaped lens. Sent sample to a manufacturer in Taiwan, they advised us that they could make lens as our specifications using a PC SG/0.75 smoke colored polarized lens with a 2.3 AC lens for clear area. The 2.3 clear lens is inserted through the cut out of polarized lens, the clear is thicker so it sticks out in front and back of lens. The manufacturer sent us a sample as per our specifications for the lens, after receiving sample we placed order with them for shipment.

1. The subject matter is the lens, that the clear lens inserted and positioned through the polarized lens lets you see your playing cards clearly when looking down at them while hiding your eyes from other players by way of the polarized section of lens.
